(19) United States
(12) Patent Application Publication
(10) Pub. No.: US 2004/0195054 A1
(43) Pub. Date: Oct. 7, 2004

(54) Cell caliper for disc brakes

(76) Inventor: Robert Charles Thomas, Willowbrook, IL (US)

Correspondence Address: Robert Thomas, 430 Village Rd., Willowbrook, IL, 60527, US

(21) Appl. No.: 10/817,110

(22) Filed: Apr. 2, 2004

Related U.S. Application Data
(60) Provisional application No. 60/459,598, filed on Apr. 2, 2003.

(51) Int. Cl. F16D 65/00

(52) U.S. Cl. 188/73.1

(57) ABSTRACT

A disc brake caliper housing having inboard and outboard walls each connected by a corner to a bridge. A piston is slidably mounted in a bore on one wall. At least one corner is comprised of discrete ribs. The ribs permit easy removal of bridge material in the casting process to create concavities of predetermined shape for subsequent machining, part handling, and component mounting as well as light weight with high bending stiffness.

### RELATED APPLICATIONS

This application is entitled to the benefit of Provisional Patent Application Ser No. 60/459,598 filed Apr. 2, 2003.

### BACKROUND

The field of the present invention is that of calipers for use in automotive disc brakes. As known in the art, typical automotive disc brakes include a caliper, which is slidably mounted to a vehicle and in which a piston is slidably mounted to the inboard side of said caliper. The actuation of the piston in the caliper bore pushes the inboard brake shoe into the rotor, and the reaction therefrom causes the caliper to slide and pull the outboard shoe into the rotor. The reaction forces thus generated bend the caliper. Certain ratios of deflection to actuation force, i.e., caliper stiffness, are correlated with desirable levels of performance characteristics such as brake power and feel. Generally, this is achieved by thicker cross-sections, particularly through the bridge area; and this of necessity causes an increase in component and overall vehicle weight; and detracts from vehicle handling, as the caliper represents unsprung mass in the vehicle suspension. The typical approach to weight reduction consists of casting or machining holes through the entirety of the bridge in a radial direction; but such a reduction of bridge mass also significantly reduces caliper stiffness and is often counter-productive where a certain stiffness is required. Also, braking applications such as anti-lock braking are constantly being improved. But their development is constrained by a lack of space in which to mount wheel-end components such as sensors. Machining mounting surfaces is generally very expensive for millions of units. In addition, locating and clamping caliper for machining is generally time consuming, labor intensive and prone to inaccuracy.

A caliper with hollow bridge chambers has been proposed in U.S. Pat. No. 6,298,954 to Weller et al. Although intended to be light and relatively stiff, the caliper described has several significant disadvantages. It is expensive and labor-intensive to manufacture: such recesses which are delimited on all sides can only be cast by means of a complex core that has to be assembled and positioned, usually by hand. This process precludes highly accurate permanent molding techniques such as die casting. After casting, the casting material must be shaken out of the recesses. Also, the delimited recesses so created are inaccessible. They cannot be used as locations for mounting other components or as convenient locating sockets for subsequent machining. Cooling via increased airflow is no more facilitated than in the standard caliper design. Thus, given the expense and difficulty in manufacture and the corresponding limited benefit, the caliper as described in U.S. Pat. No. 6,298,954 are generally too expensive to produce.

### SUMMARY

Aspects of the present invention provide a brake caliper with one or more concavities in the bridge area and, in one embodiment, a rib structure that permits easy formation of said concavities in the casting process. A brake caliper is provided having one or more of the following aspects: (1) a desirable level of stiffness and comparatively low weight—i.e.—an increased ratio of stiffness to weight; (2) lower associated material and shipping costs; (3) facilitation of airflow and component cooling; (4) provision of space in which to mount ancillary components such as sensors; and (5) facilitation of an improved method of locating and clamping the caliper for machining operations, as well as general handling.

This caliper can be manufactured easily without the use of complex undercut cores. It can be made by temporary molding techniques such as sand casting or by highly accurate permanent techniques such as die casting. The replacement of a continuous corner by a discrete rib structure enables simple projections from either half of a mold to form the bridge concavities. The concavity can therefore take many specialized shapes for component and sensor mounting or sockets to facilitate caliper machining and handling. The cell geometry can be even further refine for special uses by the use of simple side actions on the projections to form surfaces that can restrain a component or fixture inserted into a concavity for a fast and inexpensive “snap fit”, by forming holes in the sides of the ribs or through the upper or lower bridge surfaces. This development vastly improves the efficiency, utility and economy of the disc brake caliper. The gap between the side walls that contains the pads and rotor can then be formed as it is in current designs by a simple core or side action.

### DRAWINGS

FIG. 1 is an isometric view of a typical example of the prior art.

FIG. 2 is a top view of FIG. 1.

FIG. 3 is a cross-section of the brake caliper of FIGS. 1 and 2 taken parallel to the vehicle wheel axis.

FIG. 4 is an isometric view of a brake caliper constructed in accordance with the invention.

FIG. 5 is a top view of the brake caliper of FIG. 4.

FIG. 6 is a cross-section of the brake caliper of FIGS. 4 and 5 taken parallel to the vehicle wheel axis.

FIG. 7 is a cross-section of the brake caliper of FIGS. 4 and 5 taken perpendicular to the vehicle wheel axis.

FIG. 8 is a back view of another embodiment of the invention.

FIG. 9 is an isometric view of another embodiment of the invention.

### DESCRIPTION

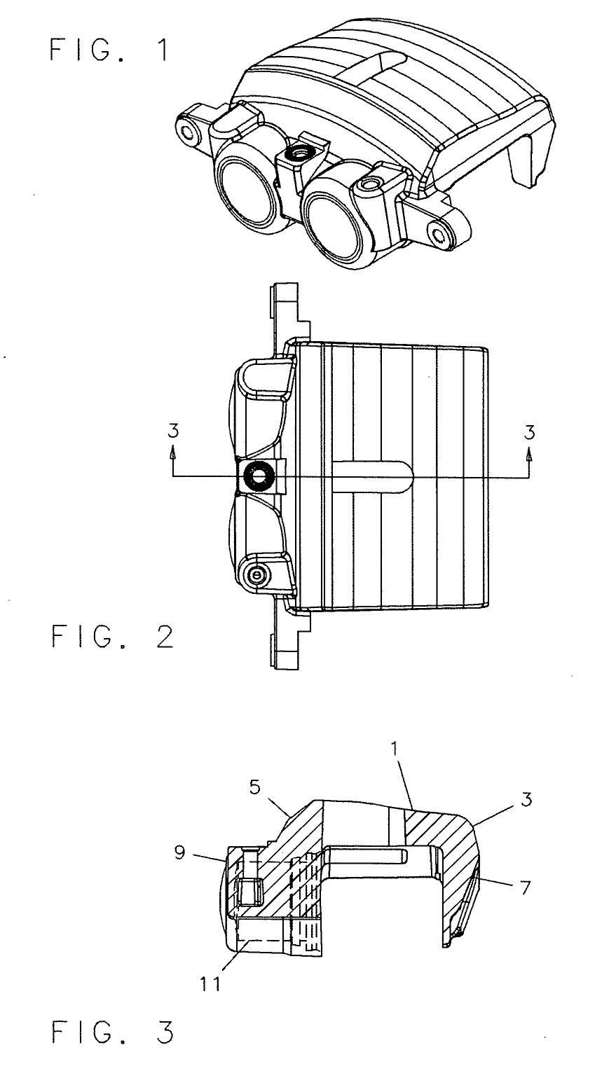

According to FIGS. 1-3, a brake caliper typically comprises a bridge 1, and inboard 9 and outboard 7 side walls, which are joined to the bridge by inboard 5 and outboard 3 corner regions, respectively. In the housing on the inboard side wall 9 is a bore 11 and an actuating cylinder not shown.

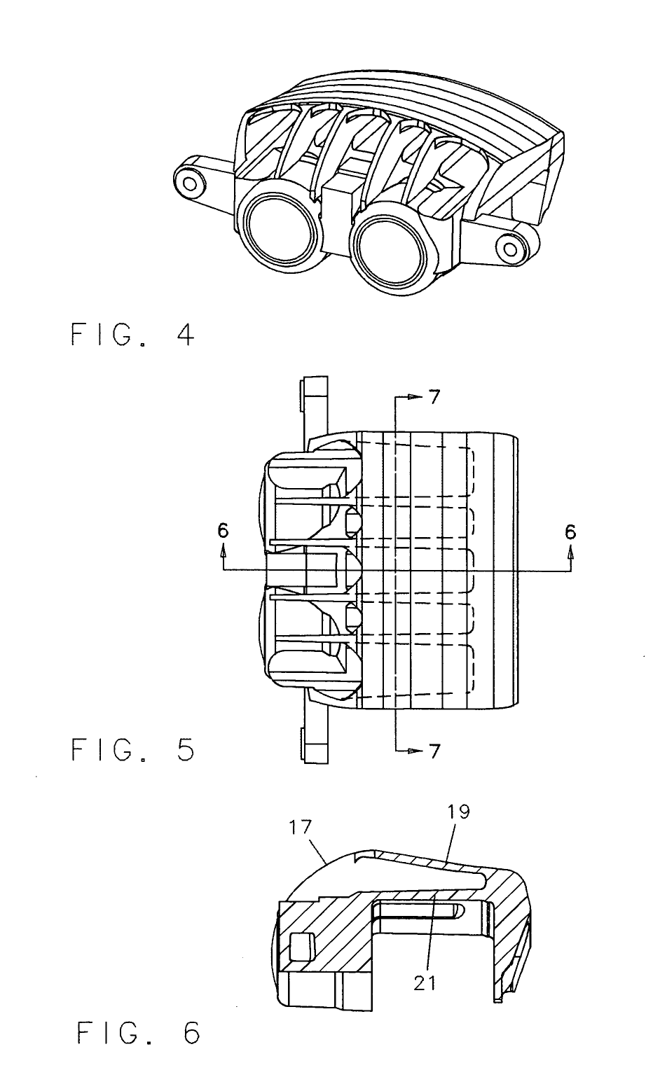

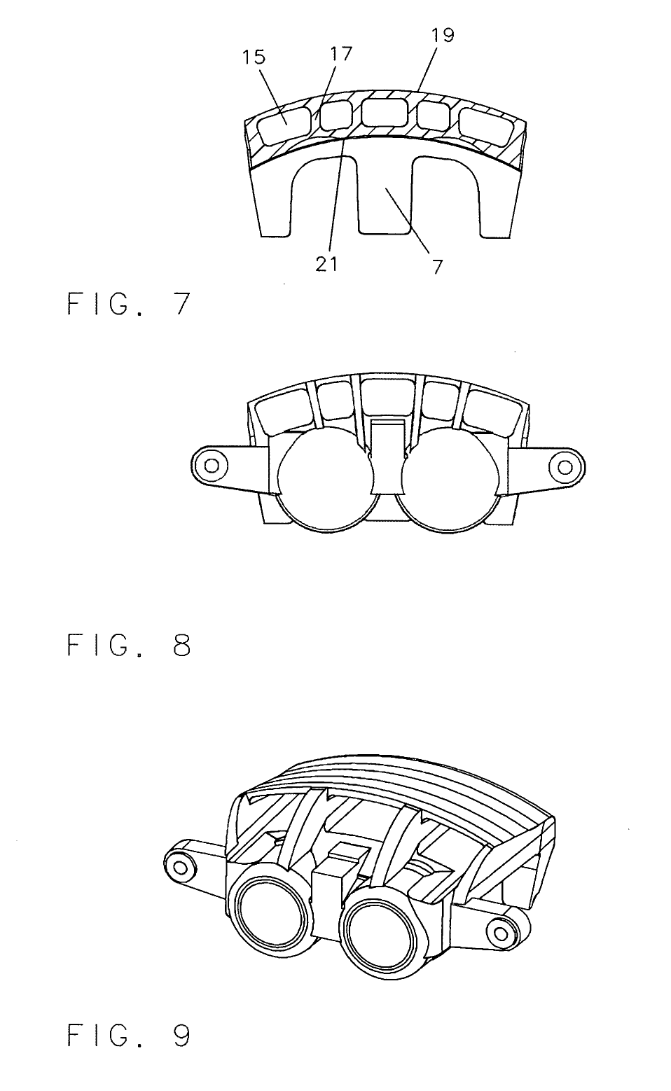

FIGS. 4-7 show the preferred embodiment of the invention in which concavities 15 in the bridge 1 are extended through the inboard corner 5. The concavities 15 represent the removal of the bridge material that contributes very little to the bending stiffness of the caliper bridge, i.e., the material closest to the neutral plane or surface. The material most involved in resisting bending the upper 19 and lower 21 radial surfaces are left intact. Thus, the caliper has substantially the same stiffness as a one with a solid bridge cross-section, but is significantly lighter. Because the concavities are extended through the inboard corner, they can be easily formed in the casting process by projections or fingers in the mold, including permanent die castings and sand castings. Ribs 17 enforce the connection between the upper 19 and lower 21 radial surfaces, preventing them from buckling and forcing them to act as parts of one integral cross-section. The reduction in stiffness of the inboard corner due to the extension of the concavities 15 is compensated by the increased profile of the ribs 17 near the corner. The bending stiffness of the set of discrete ribs 17, each with a locally higher moment of inertia, equals that of a continuous corner with a lower moment of inertia.

An optimal use of this embodiment may be for an aluminum caliper which is formed in a permanent mold. Due to the tighter tolerances available, the wall sections can generally be as thin as 5-6 mm. and the weight savings maximized, as much as 20 percent; and aluminum is generally the most expensive material from which calipers are made, costing approximately 40 cents per pound or more.

Other embodiments include variations in the number, spacing, and shape of the concavities 15 and the angle and profile of the ribs 17. FIG. 8 shows an embodiment wherein the ribs are aligned radially. FIG. 9 shows an embodiment with three concavities and two thicker ribs.

An embodiments not shown is one in which both corners are replaced by rib structures which may or may not be aligned with each other; and in which the concavities are open at both ends of the bridge. Also not shown is an example of an embodiment in which the surfaces of the concavities are formed into mounting surfaces for particular components—for example, traction control sensors or wiring, or damping baffles for vibration and sound reduction; or locating features or “sockets” for particular tooling arrangements.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A brake caliper for automobiles, comprising:
A. a bridge with at least one concavity,
B. two side walls which are perpendicular to said bridge on at least one of which is at least one bore containing a piston,
C. two corners joining said side walls to said bridge:
D. at least one concavity passing through at least one corner.
Whereby said concavities can easily be formed in a casting.

2. The brake caliper of claim 1 wherein said concavities are aligned with the wheel axis and said corner comprises a discrete rib structure around said concavities, said ribs continuing through said bridge.
Whereby the ribs mechanically integrate the upper and lower radial walls of the bridge and partition the bridge into cells.

3. The brake caliper of claim 2 wherein the lateral profile of said ribs is increased to a predetermined size and shape.
Whereby the stiffness lost in said corner due to said concavities is compensated by an increase in the bending stiffness of the intervening ribs.

4. The brake caliper of claim 1 wherein at least one concavity is shaped to accommodate means for fixturing, locating, clamping or handling said caliper.

5. The brake caliper of claim 1 wherein at least one concavity is shaped to accommodate means for mounting other components.
